(19) United States
(12) Patent Application Publication
(10) Pub. No.: US 2014/0295108 A1
(43) Pub. Date: Oct. 2, 2014

(54) ADHESIVE COMPOSITION, POLARIZING PLATE AND LIQUID CRYSTAL DISPLAY DEVICE COMPRISING THE SAME

(71) Applicants: Eun-Gu Han, Seoul (KR); Sang-Jin Lee, Gyeonggi-do (KR); Kyung-Moon Jung, Gyeonggi-do (KR)

(72) Inventors: Eun-Gu Han, Seoul (KR); Sang-Jin Lee, Gyeonggi-do (KR); Kyung-Moon Jung, Gyeonggi-do (KR)

(73) Assignee: DONGWOO FINE-CHEM CO., LTD., Jeollabuk-do (KR)

(21) Appl. No.: 14/130,005

(22) PCT Filed: May 16, 2012
(86) PCT No.: PCT/KR2012/003824

§ 371 Date: Jan. 23, 2014

(30) Foreign Application Priority Data
Jun. 28, 2011 (KR) 10-2011-0062746

(51) Int. Cl. C09J 11/06; G02F 1/1335

(52) U.S. Cl. CPC C09J 11/06; G02F 1/133528
USPC 428/1.55; 524/300

(57) ABSTRACT

The present invention discloses an adhesive composition, and a polarizing plate and liquid crystal display device including the same. More particularly, there are provided an adhesive composition which includes an acrylic copolymer having a functional group cross-linkable with isocyanate, a toluene diisocyanate-based cross-linking agent and an organic acid stabilizer, to inhibit a change in viscosity so as to improve storage stability and assure a sufficient pot-life, which in turn, improves process stability but reduces a curing time, thereby enhancing productivity, as well as a polarizing plate and liquid crystal display device including the same.

### CROSS REFERENCE TO RELATED APPLICATIONS

This application is a National Phase application under 35 U.S.C. §371 of International Application No. PCT/KR2012/003824, filed on May 16, 2012, which claims priority to and the benefit of Republic of Korea Patent Application No. 10-2011-0062746 filed on Jun. 28, 2011, the disclosure of which is incorporated herein by reference in its entirety.

### BACKGROUND

1. Field of the Invention

The present invention relates to an adhesive composition that controls changes in viscosity to improve process stability, and can reduce curing times to enhance productivity, as well as, a polarizing plate and liquid crystal display device including the same.

2. Background Art

A liquid crystal display device (LCD) has a liquid crystal panel that includes a liquid crystal cell and polarizing plates bonded to both faces of the liquid crystal cell through adhesive layers.

An adhesive used for binding the liquid crystal cell and the polarizing plate must simultaneously satisfy physical properties such as reworkable properties, adhesiveness to a substrate, light leakage prevention, heat resistance, moist heat resistance, durability, or the like. In addition to the improvement of the physical properties, as described above, the adhesive must reduce curing times, thus further enhancing productivity.

As such, in order to reduce curing times while maintaining the desired physical properties of a conventional adhesive, Korean Patent Laid-Open Publication No. 2008-0047030 discloses an adhesive composition including a Lewis acid as a cross-linkage enhancer to promote cross-linking reactions. Although the adhesive composition having such a configuration, as described above, can reduce curing times to enhance productivity, while also satisfying adhesion durability, cutting characteristics, light leakage prevention, light transmission, or the like, there are still the disadvantages of poor storage stability and short pot-lives of adhesives due to a sharp change in viscosity.

### SUMMARY

It is an object of the present invention to provide an adhesive composition that inhibits changes in viscosity to assure sufficient pot-life and the improvement of process stability, and reduces curing times without using any cross-linking enhancer, thus enhancing productivity.

The present invention also provides a polarizing plate having an adhesive layer that includes the foregoing adhesive composition and is laminated thereon.

Yet another provision of the present invention is a liquid crystal display device including the polarizing plate provided on at least one face of a liquid crystal cell.

In order to realize the present invention the following is provided:

(1) An adhesive composition including: an acrylic copolymer having a functional group cross-linkable with isocyanate; a toluene diisocyanate-based cross-linking agent; and an organic acid stabilizer.

(2) The composition according to the above (1), wherein the organic acid stabilizer has a boiling point of 150° C. or less.

(3) The composition according to the above (2), wherein the organic acid stabilizer is at least one selected from a group consisting of acetic acid, formic acid, and acrylic acid.

(4) The composition according to the above (1), wherein the organic acid stabilizer is included in an amount of 0.001 to 12 weight parts to 100 weight parts of the acrylic copolymer in terms of solid content.

(5) The composition according to the above (1), wherein the toluene diisocyanate-based cross-linking agent is included in an amount of 0.01 to 15 weight parts to 100 weight parts of the acrylic copolymer in terms of solid content.

(6) The composition according to the above (1), further including a Lewis acid cross-linkage enhancer.

(7) A polarizing plate comprising an adhesive layer laminated thereon, wherein the adhesive layer is formed using the adhesive composition according to any one of the above (1) to (6).

(8) A liquid crystal display device including the polarizing plate according to the above (7) provided on at least one face of a liquid crystal cell.

The adhesive composition according to the present invention may have controlled changes in viscosity through the reaction of a stabilizer for regulating the activities of an acrylic copolymer and toluene diisocyanate-based cross-linking agent, this will be manifested in excellent storage stability and will assure a sufficient pot-life, thereby improving process stability.

Further, the adhesive composition of the present invention can remarkably reduce curing times without using a cross-linking enhancer, while maintaining the physical properties of any conventional adhesive.

### DETAILED DESCRIPTION OF THE INVENTION

The present invention discloses an adhesive composition that controls changes in viscosity to improve process stability, and is capable of reducing curing times to enhance productivity, as well as, a polarizing plate and liquid crystal display device including the same.

Hereinafter, the present invention will be described in more detail.

An adhesive composition of the present invention may include an acrylic copolymer having a functional group cross-linkable with isocyanate, a toluene diisocyanate-based cross-linking agent, and an organic acid stabilizer.

The acrylic copolymer having a functional group cross-linkable with isocyanate may be a copolymer formed of a methacrylate monomer that contains an alkyl group having 1 to 12 carbon atoms (hereinafter, referred to as ‘C₁ to C₁₂ alkyl group’), and a monomer having a functional group cross-linkable with isocyanate. Herein, methacrylate means both acrylate and methacrylate.

The methacrylate monomer having C₁ to C₁₂ alkyl group may include, for example, n-butyl methacrylate, 2-butyl methacrylate, t-butyl methacrylate, isobutyl methacrylate, 2-ethylhexyl methacrylate, 2-ethylbutyl methacrylate, ethyl methacrylate, methyl methacrylate, n-propyl methacrylate, isopropyl methacrylate, pentyl methacrylate, n-octyl methacrylate, isooctyl methacrylate, nonyl methacrylate, decyl methacrylate, lauryl methacrylate, or the like, which are used alone or in combination with two or more thereof. Among these, n-butyl acrylate, 2-ethylhexyl acrylate, or a mixture thereof is preferably used.

Preferably, the methacrylate monomer having a C₁ to C₁₂ alkyl group is included in an amount of 80 to 99.9 weight %, and more preferably, 90 to 98 weight % to a total 100 weight % of the monomer used for preparing an acrylic copolymer. If the content of the methacrylate monomer is less than 80 weight %, the adhesion will be insufficient. When the content of the methacrylate monomer exceeds 99.9 weight %, the durability may be reduced due to a decrease in cohesion.

The monomer having a functional group cross-linkable with isocyanate is a component that reinforces the cohesion or adhesive intensity of the adhesive composition, and provides durability and improved cutting characteristics thereto through the chemical bonding between the same and an isocyanate-based cross-linking agent. The monomer may include, for example, a monomer having a hydroxyl group, a monomer having a carboxyl group, a monomer having an amide group, a monomer having a tertiary amine group, a monomer having a vinyl group, or the like, which can be used alone or in combination with two or more thereof.

The monomer having a hydroxyl group may include hydroxylalkyleneglycol methacrylate having a C₂ to C₄ alkylene group, such as 2-hydroxyethyl methacrylate, 2-hydroxypropyl methacrylate, 2-hydroxybutyl methacrylate, 4-hydroxybutyl methacrylate, 6-hydroxyhexyl methacrylate, 2-hydroxyethyleneglycol methacrylate, 2-hydroxylpropyleneglycol methacrylate, or the like. Among these, 2-hydroxylethyl methacrylate is preferably used.

The monomer having a carboxyl group may include: a monocarboxylic acid, such as methacrylic acid, crotonic acid, 2-carboxyethyl methacrylate, and the like; a dicarboxylic acid such as maleic acid, itaconic acid, fumaric acid, and the like, or monoalkylesters thereof; 3-methacryloyl propionic acid; an anhydrous succinic acid ring-opened adduct of 2-hydroxyalkyl methacrylate having a C₂ to C₃ alkyl group, an anhydrous succinic acid ring-opened adduct of hydroxyalkyleneglycol methacrylate having a C₂ to C₄ alkylene group, a compound polymerized by ring-opening addition of anhydrous succinic acid to a caprolactone adduct of 2-hydroxyalkyl methacrylate having a C₂ to C₃ alkyl group, or the like.

The monomer having an amide group may include, for example, methacrylamide, N-isopropyl acrylamide, N-tert-butyl acrylamide, or the like. Among these, methacrylamide is preferably used.

The monomer having a tertiary amine group may include, for example, N,N-(dimethylamino)ethyl methacrylate, N,N-(diethylamino)ethyl methacrylate, N,N-(dimethylamino)propyl methacrylate, or the like.

The monomer having a vinyl group may include, for example, N-vinyl pyrrolidone, N-vinyl carpolactam, or the like.

Preferably, the monomer having a functional group cross-linkable with isocyanate is included in an amount of 0.1 to 20 weight %, and more preferably, 0.5 to 10 weight % to a total 100 weight % of the monomer used for preparing an acrylic copolymer. If the content of the above monomer is less than 0.1 weight %, cohesion of the adhesive decreases thereby reducing durability.

When the content of the above monomer exceeds 20 weight %, it may cause a decrease in adhesion and problems with durability due to a high gel fraction rate.

Other than the above monomers, another polymerizable monomers may be further included within a range in that does not decrease adhesion, for example, a range of 10 weight % or less.

A method for the preparation of the copolymers is not particularly limited, and may include, agglomerate polymerization, solution polymerization, emulsion polymerization, or suspension polymerization, and preferably, solution polymerization is used. Furthermore, a solvent, polymerization initiator, chain transfer agent, or the like, which are generally used in polymerizations, may be further used.

The acrylic copolymer may have a weight average molecular weight (MW; in terms of polystyrene), which is measured by gel permeation chromatography (GPC), ranging from 50,000 to 2,000,000, and preferably, 100,000 to 1,500,000.

The cross-linking agent is a component of suitably cross-linking the acrylic copolymer to strengthen the cohesion of the adhesive and, in particular, a toluene diisocyanate-based cross-linking agent, among other isocyanate cross-linking agents, is preferably used.

The toluene diisocyanate-based cross-linking agent may include, for example: an adduct formed by treating 1 mole of a polyalcohol compound, such as trimethylolpropane, or the like, with 3 moles of toluene diisocyanate, an isocyanurate compound (e.g., prepared by self-condensation of 3 moles of toluene diisocyanate); a biuret compound (e.g., prepared by condensation of toluene diisocyanate urea obtained from 2 moles of toluene diisocyanate among 3 moles thereof with the remaining 1 mole of toluene diisocyanate, or the like.

Preferably, the toluene diisocyanate-based cross-linking agent is included in an amount of 0.01 to 15 weight parts, and more preferably, 0.2 to 5 weight parts to 100 weight parts of the acrylic copolymer in terms of solid content. If the content of the cross-linking agent is less than 0.01 weight parts, cohesion is decreased due to a lack of the degree of cross-linking, hence causing reductions in durability, such as excited state, and deterioration of cutting characteristics. On the other hand, when the content of the cross-linking agent exceeds 15 weight %, a reduction in durability may occur and the storage stability may be deteriorated due to excessive cross-linking reactions.

The present invention is characterized by including an organic acid stabilizer that can regulate activity in the cross-linking reaction between a toluene diisocyanate-based cross-linking agent and an acrylic copolymer having a functional group cross-linkable with the isocyanate.

More particularly, the organic acid stabilizer may reduce the activity of the acrylic copolymer and the toluene diisocyanate-based cross-linking agent in an adhesive composition before coating, effectively inhibiting a change in viscosity and assuring storage stability, and then can be volatilized from the adhesive composition after coating, thereby increasing the efficiency of the cross-linking reaction. Consequently, the process stability and the effects of reducing curing times may be simultaneously assured.

The kinds of organic acids used as a stabilizer are not particularly limited, and may include, for example, malonic acid, succinic acid, glutamic acid, oxalic acid, acetic acid, ethoxyacetic acid, methoxyacetic acid, formic acid, trifluoroacetic acid, acrylic acid, or the like, which can be used alone or in combination with two or more thereof. Among these, acetic acid, formic acid, trifluoroacetic acid, and acrylic acid, which all have boiling points of less than 150° C., are preferably used. Furthermore, the organic acids having a boiling point of 120° C. or less (i.e., acetic acid, formic acid, and trifluoroacetic acid) are more preferably used since they can be easily removed via volatilization after coating or drying the adhesive composition, and may improve the efficiency of the cross-linking reaction.

The organic acid stabilizer may be included in an amount of 0.001 to 12 weight parts, preferably, 0.005 to 8 weight parts, and more preferably, 0.1 to 5 weight parts to 100 weight % of the acrylic copolymer in terms of solid content. If the content of the organic acid stabilizer is less than 0.001 weight parts, it is difficult to sufficiently reduce the activities of the acrylic copolymer and cross-linking agent after preparing the adhesive composition, hence minimally inhibiting the changes in viscosity. When the content of the organic acid stabilizer exceeds 12 weight parts, it will not be completely volatilized, and remains in the adhesive during drying, hence reducing the physical adhesion properties and the durability.

The foregoing adhesive composition may further include a Lewis acid cross-linking enhancer.

The kinds of Lewis acid cross-linking enhancers are not particularly limited, and may include, for example, metal halides or organometallic compounds, which have an ability to accept electrons, and are represented by formula 1.

(R₁)ₙM(═O)ₘ [Formula 1]

Wherein R₁ is at least one organic group selected from the group consisting of a halogen atom, an alkoxy group having 1 to 20 carbon atoms substituted or non-substituted by an alkyl, aryl or acyl group having 1 to 20 carbon atoms, and an acyloxy group; M is B, Mg, Al, Ca, Sn, Pb or a transitional metal atom belonging to any one of the 3A to 7A groups and the 1B group; n is an integer ranging from 1 to 6; and m is an integer ranging from 0 to 2.

Metals for formation of the Lewis acids are classified according to the IUPAC nomenclature of inorganic chemistry. Particular examples of the Lewis acids may include: metal halides such as boron trifluoride, aluminum trichloride, titanium trichloride, titanium tetrachloride, ferrous chloride, ferric chloride, zinc chloride, zinc bromide, stannous chloride, stannic chloride, stannous bromide, stannic bromide, and the like; or organometallic compounds such as trialkylboron, trialkylaluminum, dialkylaluminum halide, monoalkylaluminum dihalide, tetraalkyltin, aluminum acetylacetonate, iron acetylacetonate, zirconium acetylacetonate, dibutyltin oxide, dibutyltin acetylacetonate, dibutyltin dilaurate, dioctyltinester maleate, magnesium naphthenate, calcium naphthenate, manganese naphthenate, iron naphthenate, cobalt naphthenate, copper naphthenate, zinc naphthenate, zirconium naphthenate, lead naphthenate, calcium octanoate, manganese octanoate, iron octanoate, cobalt octanoate, zinc octanoate, zirconium octanoate, tin octanoate, lead octanoate, zinc laurate, magnesium stearate, aluminum stearate, calcium stearate, cobalt stearate, zinc stearate, lead stearate, and the like, which can be used alone or in combination with two or more thereof. Among these, dibutyltin dilaurate is preferably used.

A Lewis acid cross-linking enhancer may be included in an amount of 0 to 1 weight part, and preferably, 0.001 to 0.5 weight parts to 100 weight parts of the acrylic copolymer in terms of solid content. If the content of the cross-linkage enhancer exceeds 1 weight part, the physical adhesion properties may be deteriorated due to over-curing of the adhesive.

The adhesive composition of the present invention may further include a silane coupling agent.

The kinds of silane coupling agents are not particularly limited and may include, for example, vinylchlorosilane, vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyldiethoxysilane, 3-glycidoxypropyltriethoxysilane, p-styryltrimethoxysilane, 3-methacryloxypropyltriethoxysilane, 3-methacryloxypropyltrimethoxysilane, 3-methacryloxypropylmethyldimethoxysilane, 3-methacryloxypropylmethyldiethoxysilane, 3-acryloxypropyltrimethoxysilane, N-2-(aminoethyl)-3-aminopropylmethyldimethoxysilane, N-2-(aminoethyl)-3-aminopropyltrimethoxysilane, N-2-(aminoethyl)-3-aminopropylmethyltriethoxysilane, 3-aminopropyltrimethoxysilane, 3-aminopropyltriethoxysilane, 3-triethoxysylyl-N-(1,3-dimethylbutylidene)propylamine, N-phenyl-3-aminopropyltrimethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanatopropyltriethoxysilane, or the like, which can be used alone or in combination with two or more thereof.

The silane coupling agent may be included in an amount of 0 to 10 weight parts, and preferably, 0.005 to 5 weight parts to 100 weight parts of the acrylic copolymer in terms of solid content. If the content of the silane coupling agent exceeds 10 weight parts, the durability may be reduced.

Other than the foregoing components, the adhesive composition may further include tackifier resins, antioxidants, anti-corrosive agents, leveling agents, surface lubricants, dyes, pigments, de-foaming agents, fillers, light stabilizers, antistatic agents, or the like, so as to control adhesion, cohesion, viscosity, elastic modulus, glass transitional temperature, antistatic properties, or the like.

The adhesive composition having such a technical configuration as described above may inhibit changes in viscosity of the adhesive composition through the activity of the organic acid stabilizer before coating to assure a sufficient pot-life and improve the process stability, while maintaining the physical properties of a conventional adhesive, and may further promote a cross-linking reaction after coating to remarkably reduce curing times, thereby enhancing productivity.

The adhesive composition of the present invention may be employed as an adhesive for a surface protective film as well as an adhesive for a polarizing plate that is used for bonding the same to a liquid crystal cell. Furthermore, it may be also applied to a protective film, a reflective sheet, an adhesive sheet for a structure, an adhesive sheet for pictures, an adhesive sheet for marking road lanes, adhesive products for optical use, an adhesive for electronic parts, and in addition, commercially available adhesive sheet products, medical patches, or the like.

The polarizing plate of the present invention may have an adhesive layer formed of the adhesive composition, which is laminated on the polarizing plate.

The thickness of the adhesive layer may be adjusted according to the adhesion thereof and, in general, preferably ranges from 3 to 100 μm, and more preferably, 10 to 100 μm.

Such a polarizing plate as described above may be applicable to any conventional liquid crystal display device and, in particular, may form a liquid crystal display device provided with a liquid crystal panel that includes a liquid crystal cell and the polarizing plate having the adhesive layer laminated thereon, which is provided on at least one face of the liquid crystal cell.

Hereinafter, preferred embodiments will be described to more thoroughly understand the present invention. However, it will be apparent to those skilled in the art that such embodiments are provided for illustrative purposes without particular limitation to the appended claims. Various modifications and alterations may be possible without departing from the scope and spirit of the present invention, and such modifications and alterations are duly included in the present invention as defined by the appended claims.

### EXAMPLES

### Preparative Example 1

### Acrylic Copolymer

A monomer mixture including 97 weight parts of n-butylacrylate (BA), 2 weight parts of 2-hydroxyethylacrylate (2HEA), 0.5 weight parts of acrylic acid (AA) and 0.5 weight parts of 2-carboxyethylacrylate (2CEA) were introduced into an 1L reactor equipped with a cooling device to easily control the temperature and with a refluxer and nitrogen gas. Then, 100 weight parts of ethylacetate (EA) as a solvent was added. Thereafter, in order to remove oxygen, nitrogen gas was introduced for 1 hour to purge the air in the reactor while the temperature was kept at 62° C. After uniformly stirring the monomer mixture, 0.07 weight parts of azobisisobutyronitrile (AIBN), as a reaction initiator, was introduced followed by allowing the reaction to stir for 8 hours to prepare an acrylic copolymer having a weight average molecular weight of 500,000 or higher.

### Example 1

(1) Adhesive Composition

In terms of solid content, 100 weight parts of the acrylic copolymer obtained in Preparative Example 1, 0.5 weight parts of a toluene diisocyanate adduct of trimethylolpropane as a cross-linking agent (COR-L, Nippon polyurethane Industry Co.), 1 weight part of 3-glycidoxypropyltrimethoxysilane (KBM-403, ShinEtsu Co.) as a silane coupling agent, and 0.5 weight parts of acetic acid (AcA) as a stabilizer were mixed together and then diluted to reach a concentration of 25% in consideration of coating properties. As a result, an adhesive composition was prepared.

(2) Adhesive Sheet

The prepared adhesive composition was applied to a silicon releasing agent-coated film until a thickness after drying reached 25 μm, then it was dried at 100° C. for 1 minute to form an adhesive layer. Then, another layer formed of release film was laminated on the adhesive layer to prepare an adhesive sheet.

(3) Adhesive-Coated Polarizing Plate

After the release film was delaminated from the prepared adhesive sheet, the adhesive layer was adhered to an iodine-based polarizing plate with a thickness of 185 μm, so as to form an adhesive-coated polarizing plate.

### Examples 2 to 8, Comparative Examples 1 and 2

The same procedure as described in Example 1 was conducted except that the components of the adhesive composition and the contents thereof used therein are shown in Table 1, below. In this regard, the content was defined in parts by weight.

TABLE 1

| | | Cross- | Silane | | | | |
|---|---|---|---|---|---|---|---|
| | | linking | coupling | | | | |
| | | agent | agent | Lewis acid | | Organic acid | |
| Section | Copolymer | Cor-L | KBM-403 | Kind | Content | Kind | Content |
| Example 1 | 100 | 0.5 | 1 | — | — | AcA | 0.5 |
| Example 2 | 100 | 0.5 | 1 | — | — | AcA | 0.01 |
| Example 3 | 100 | 0.5 | 1 | — | — | AcA | 10 |
| Example 4 | 100 | 0.5 | 1 | — | — | AcA | 3 |
| Example 5 | 100 | 0.5 | 1 | — | — | AcA | 15 |
| Example 6 | 100 | 0.5 | 1 | — | — | AcA | 0.001 |
| Example 7 | 100 | 0.5 | 1 | — | — | AA | 0.5 |
| Example 8 | 100 | 0.5 | 1 | DBTDLA | 0.05 | AcA | 0.5 |
| Comparative | 100 | 0.5 | 1 | — | — | — | — |
| Example 1 | | | | | | | |
| Comparative | 100 | 0.5 | 1 | DBTDLA | 0.05 | — | — |
| Example 2 | | | | | | | |

Cor-L: Toluene diisocyanate adduct of trimethylolpropane (Nippon polyurethane Industry Co.)
KBM-403: 3-glycidoxypropyl trimethoxysilane (ShinEtsu Co.)
DBTDL: Dibutyltin dilaurate
AcA: Acetic acid
AA: Acrylic acid

### Experimental Example

The physical properties of each of the adhesive compositions and adhesive-coated polarizing plates prepared in the foregoing examples and the comparative examples were measured by the following method, and the results of the measurements are shown in Table 2, below.

1. Storage Stability (Change in Viscosity)

An initial viscosity of the prepared adhesive composition and the viscosity after leaving the composition untreated for 24 hours were measured by means of a viscometer (Brookfield LVDV-II+B type; spindle No. 3, 30 rpm). The change rate (Δη) of measured viscosities was calculated and then evaluated according to the following standards.

Standards for evaluation

∘: 5%≦Δη<10%

Δ: 5%≦Δη<15%

×: 15%≦Δη

2. Adhesion (N/25 mm)

The adhesive-coated polarizing plate formed above was cut into 25 mm×150 mm sizes and, after delaminating the release film, a cut piece of the polarizing plate was laminated on a glass plate (#1737, Corning Co.) at a pressure of 0.25 MPa, followed by autoclaving to fabricate a specimen. Using a universal testing machine (UTM, Instron) and by delaminating the adhesive layer at a release rate of 300 mm/min and a release angle of 180°, the adhesion at room temperature was measured after leaving the fabricated specimen untreated under the conditions of 23° C. and 50% RH for 24 hours, and the adhesion at elevated temperature was measured after leaving the fabricated specimen untreated under the conditions of 50° C. and 50% RH for 48 hours, respectively. In this regard, the measurement was conducted under the conditions of 23° C. and 50% RH.

3. Durability (Heat Resistance, Moist Heat Resistance)

After cutting the formed adhesive-coated polarizing plate into 90 mm×170 mm sizes and delaminating the release film from the polarizing plate, the cut piece of the polarizing plate was adhered to both faces of a glass plate (110 mm×190 mm×0.7 mm) in such a way that the optical absorption axes cross at right angles, so as to fabricate a specimen. The pressure applied in the above process was 5 kg/cm² and the process was executed in a clean room in order to prevent bubbles or impurities from being generated. With regard to heat resistance, whether bubbling or delamination occurred was observed after leaving the specimen untreated at a temperature of 80° C. for 1,000 hours. Alternatively, with regard to moist heat resistance, whether bubbling or delamination occurs was observed after leaving the specimen untreated under conditions of 60° C. and 90% RH for 1,000 hours. In this regard, just before evaluating the states of the specimen, the specimen was left untreated at room temperature for 24 hours and then observed.

Standards for evaluation

⊚: no bubbling or delamination

∘: bubbles or delamination<5 (in numbers)

Δ: 5≦bubbles or delamination<10

×: 10≦bubbles or delamination

4. Gel Fraction Rate (%)

The adhesive-coated polarizing plate formed was cured under conditions of 23° C. and 65% RH for 1 day. About 0.25 g of the adhesive layer in the adhesive-coated polarizing plate was attached to a precisely weighed wire mesh (250 mesh; 100 mm×100 mm) and the mesh was 0wrapped to prevent a gel fraction from being leaked. Using a precision balance, the weight of the wire mesh was accurately measured and the wire mesh was immersed in an ethyl acetate solution for 3 days. After taking the immersed wire mesh out of the ethyl acetate solution, it was rinsed using a small amount of ethyl acetate solution and dried at 120° C. for 24 hours, followed by measuring the weight thereof. Using the measured weight, a gel fraction rate was calculated according to the mathematical Equation 1, below.

$$Gel fraction rate ( \% ) = \frac{( C - A )}{( B - A )} \times 100 \qquad Mathematical Equation 1$$

(wherein A denotes the weight of the wire mesh (g), B denotes the weight of the wire mesh having an adhesive layer attached thereto (B−A: the weight of adhesive (g)), and C denotes the weight of the wire mesh dried after immersion (C−A: the weight of gelled resin (g)).

TABLE 2

| | | | | Durability | | |
|---|---|---|---|---|---|---|
| | | Adhesion (N/25 mm) | | | Moist | Gel |
| | Storage | Room | Elevated | Heat | Heat | Fraction |
| Section | Stability | Temperature | Temperature | Resistance | Resistance | Rate (%) |
| Example 1 | ◯ | 1.5 | 7.5 | ⊚ | ⊚ | 78.8 |
| Example 2 | ◯ | 1.7 | 8.2 | ◯ | ◯ | 76.5 |
| Example 3 | ◯ | 2.5 | 10.1 | ◯ | ◯ | 73.2 |
| Example 4 | ◯ | 1.9 | 9.3 | ⊚ | ◯ | 75.3 |
| Example 5 | Δ | 2.6 | 10.3 | ◯ | Δ | 70.5 |
| Example 6 | Δ | 1.7 | 8.5 | ◯ | ◯ | 77.6 |
| Example 7 | ◯ | 1.2 | 6.4 | ◯ | Δ | 70.1 |
| Example 8 | ◯ | 1.3 | 7.8 | ◯ | ◯ | 81.6 |
| Comparative | X | 2.8 | 9.2 | ◯ | Δ | 68.2 |
| Example 1 | | | | | | |
| Comparative | X | 3.1 | 12.7 | ◯ | X | 82.2 |
| Example 2 | | | | | | |

Referring to Table 2, it was confirmed that each of the adhesive compositions according to Examples 1 to 8, which included an acrylic copolymer, a toluene diisocyanate-based cross-linking agent, and an organic acid stabilizer, had excellent adhesion and durability, as compared to the adhesive compositions according to Comparative Examples 1 and 2, while exhibiting controlled changes in viscosity, so as to have excellent storage stability and reduced curing times. In particular, in cases where the organic acid stabilizer was included in an amount of 0.005 to 8 weight parts and the organic acid stabilizer having a boiling point of 120° C. or less was used, the foregoing effects were further improved, therefore, it can be understood that the above cases are preferable.

1. An adhesive composition comprising:
an acrylic copolymer having a functional group cross-linkable with isocyanate;
a toluene diisocyanate-based cross-linking agent; and
an organic acid stabilizer.

2. The composition according to claim 1, wherein the organic acid stabilizer has a boiling point of 150° C. or less.

3. The composition according to claim 2, wherein the organic acid stabilizer is at least one selected from the group consisting of acetic acid, formic acid, and acrylic acid.

4. The composition according to claim 1, wherein the organic acid stabilizer is included in an amount of 0.001 to 12 weight parts to 100 weight parts of the acrylic copolymer in terms of solid content.

5. The composition according to claim 1, wherein the toluene diisocyanate-based cross-linking agent is included in an amount of 0.01 to 15 weight parts to 100 weight parts of the acrylic copolymer in terms of solid content.

6. The composition according to claim 1, further comprising a Lewis acid cross-linking enhancer.

7. A polarizing plate comprising an adhesive layer laminated thereon, wherein the adhesive layer is prepared by using the adhesive composition according to claim 1.

8. A liquid crystal display device comprising the polarizing plate according to claim 7 provided on at least one face of a liquid crystal cell.

9. The composition according to claim 1, wherein the acrylic copolymer is a copolymer formed of a methacrylate or acrylate monomer that contains an alkyl group having 1 to 12 carbon atoms and a monomer having the functional group cross-linkable with isocyanate; and

10. The composition according to claim 9, wherein the monomer having the functional group cross-linkable with isocyanate is selected from the group consisting of a monomer having a hydroxyl group, a monomer having a carboxyl group, a monomer having an amide group, a monomer having a tertiary amine group, a monomer having a vinyl group and a combination thereof.

11. The composition according to claim 9, wherein the methacrylate or acrylate monomer is selected from the group consisting of n-butyl methacrylate, 2-butyl methacrylate, t-butyl methacrylate, isobutyl methacrylate, 2-ethylhexyl methacrylate, 2-ethylbutyl methacrylate, ethyl methacrylate, methyl methacrylate, n-propyl methacrylate, isopropyl methacrylate, pentyl methacrylate, n-octyl methacrylate, isooctyl methacrylate, nonyl methacrylate, decyl methacrylate, lauryl methacrylate and a combination thereof.

12. The composition according to claim 11, wherein the methacrylate or acrylate monomer is n-butyl acrylate, 2-ethylhexyl acrylate, or a mixture thereof.

13. The composition according to claim 1, wherein the organic stabilizer is selected from the group consisting of malonic acid, succinic acid, glutamic acid, oxalic acid, acetic acid, ethoxyacetic acid, methoxyacetic acid, formic acid, trifluoroacetic acid, acrylic acid, and a combination thereof.

14. The composition according to claim 1, further comprising a silane coupling agent.
